(19) United States
(12) Patent Application Publication
(10) Pub. No.: US 2003/0087015 A1
(43) Pub. Date: May 8, 2003

(54) Modified atmosphere food container and method

(76) Inventors: Ihor Wyslotsky, Chicago, IL (US); Roman Forowycz, Wadsworth, IL (US); John Repp, Naperville, IL (US); George Golota, Glenview, IL (US); Bohdan Wyslotsky, Carpentersville, IL (US)

Correspondence Address: OLSON & HIERL, LTD., 36th Floor, 20 North Wacker Drive, Chicago, IL, 60606, US

(21) Appl. No.: 10/211,829

(22) Filed: Aug. 2, 2002

Related U.S. Application Data
(63) Continuation-in-part of application No. 09/924,314, filed on Aug. 7, 2001.
Application No. 09/924,314 is a continuation-in-part of application No. 09/921,361, filed on Aug. 2, 2001.

(51) Int. Cl. A23B 4/00

(52) U.S. Cl. 426/397

(57) ABSTRACT

A sealed, controlled-atmosphere food packaging container includes a self-supporting, substantially transparent, microwaveable, multilayer thermoplastic, cup-shaped body portion, and a thermoplastic closure portion sealed to the body portion. The multilayer thermoplastic material is capable of maintaining a reduced-oxygen atmosphere over a food product sealed within the container. Preferably, the cup-shaped body portion includes ribs in the form of vertical flutes or crenelations. The ribs are a functional feature of the cup providing rigidity to the cup, particularly during microwave heating of food contents within the cup. In addition, the flutes or crenelations increase the surface area of the cup, which, in turn, increases the rate of oxygen diffusion into and out of the sealed container.

### CROSS-REFERENCE TO RELATED APPLICATION

This application is a continuation-in-part of application Ser. No. 09/924,314, filed on Aug. 7, 2001, which in turn is a continuation-in-part of application Ser. No. 09/921,361, filed on Aug. 2, 2001.

### FIELD OF INVENTION

The present invention relates generally to food containers and more particularly to new methodology and structures for regulating the partial gas pressure of oxygen within a sealed food container to preserve food freshness.

### BACKGROUND OF THE INVENTION

Currently, “fast foods” include such items hamburgers, sandwiches, tacos, burritos, etc. There is a significant need to prepare these and other food items centrally to meet the requisites of both economy and food safety criteria.

Also, individual salad servings, fruit, and other foods are currently prepared at non-centrally located facilities (i.e., retail outlets). They are relatively expensive and are prepared with limited microbiological control features, if any. Indeed, and for the most part, only centrally processed foods can provide standardized and controlled quality control and safety. Moreover, better food safety control includes, for example, monitoring of the microbiological aspects of the food product, personal hygiene of food handlers, and lot identification. All these food safety aspects are far better served in a central, large scale manufacturing facility.

An important factor for providing both safety and continued freshness for a packaged food product is control of the atmosphere within the package. In particular, the level of oxygen within the container is of great importance. Packaging materials with relatively low oxygen diffusion rates are particularly appropriate for various prepared food products which are susceptible to Clostridium botulinum, whereas packaging materials with high oxygen diffusion rates are appropriate for fresh fruits and vegetables.

The invention embodied herein offers economic and safety benefits for “fast food” servings that are produced and packaged from a central location, but which have the appearance and qualities of a freshly made “in-store” servings. The food packaging containers embodied in the present invention also meet the consumer demand for convenient “fast food” products.

### SUMMARY OF THE INVENTION

A sealed, controlled-atmosphere food packaging container includes a self-supporting, substantially transparent, microwaveable, multilayer thermoplastic, cup-shaped body portion, and a thermoplastic closure portion sealed to the body portion. The thermoplastic materials of the closure and body portions of the container have selected oxygen permeability characteristics whereby the sealed container is capable of maintaining a substantially stable, reduced-oxygen atmosphere over a food product sealed within the container when the container is exposed to ambient atmosphere.

Preferably, the cup-shaped body portion (“cup”) includes ribs in the form of vertical flutes or crenelations. The ribs are a functional feature of the cup providing rigidity to the cup, particularly during microwave heating of food contents within the cup. In addition, the flutes or crenelations increase the surface area of the cup, which, in turn, increases the oxygen transmission into and out of the sealed cup.

Control of the oxygen transmission rate through of the container provides a means for controlling the atmosphere within the sealed container to aid in preserving fresh food products packaged in the container. The oxygen transmission rate can vary over a wide range depending upon the food product packaged within the container. The oxygen transmission rate can be as high as about 300 cm³/24 hr at 20° C. and 0% relative humidity.

For relatively stable, prepared foods, such as cooked meats, cooked vegetables, fresh pastas, and the like, the oxygen level of the reduced-oxygen atmosphere is maintained at a level which minimizes anaerobic bacteria growth but which still allows spoilage indicating aerobic bacteria to grow (at least about 0.2% oxygen by volume). For such foods, the oxygen transmission rate of the container preferably is no more than about 2.5 cm³/24 hr at 20° C. and 0% relative humidity.

For foods that continue to metabolize at a significant rate, such as fresh fruits, fresh vegetables, and the like, preferably, the sealed container maintains a reduced-oxygen level of no more than about 5% oxygen by volume. Preferably the oxygen transmission rate of containers for fresh fruits and vegetables is in the range of about 70 to about 300 cm³/24 hr at 20° C. and 0% relative humidity. Under these conditions, fresh fruits and vegetables can continue to respire, but at a reduced rate relative to the respiration rate in a normal, 21% oxygen atmosphere. The gas permeable container allows appropriate amounts of oxygen to enter the cup and carbon dioxide and other respiration gases to diffuse out of the cup to maintain optimum storage conditions for the particular food that is packaged within the container.

The thermoplastic materials provide for some diffusion of oxygen into the container to compensate for oxygen that has been depleted due to the continuing respiration and metabolism of the food products in the sealed container. It is also beneficial for the container to allow for diffusion of plant respiration gases out of the container.

Optimum oxygen levels are maintained by the food containers of the present invention by filling the open, cup-shaped body portion of the container with a food product under an oxygen depleted atmosphere having an oxygen content in the range of about 0.2% to about 5% (by volume) and heat-sealing the food product within the cup with a closure.

The present invention also provides a method of controlling the oxygen level within a sealed container having a food product packaged therein.

### BRIEF DESCRIPTION OF THE DRAWINGS

FIGS. 1A and 1B are perspective views of two (2) preferred embodiments of a gas permeable container embodiment of the present invention depicting alternatively a strip seal (1A) and a peelable seal (1B).

FIG. 2A is a side view of a preferred embodiment of a container of the present invention and FIG. 2B is a detailed view of the designated portion of FIG. 2A showing an attached lid with a spring action closure configuration.

FIG. 3A is a side view of an alternative embodiment of a preferred container of the present invention. FIGS. 3B-3D are cross-sectional views of portions of the container depicted in FIG. 3A. FIG. 3E is a top view of the dome-shaped lid of the container depicted in FIG. 3A.

FIG. 4 is a top view of an alternative embodiment of a dome-shaped lid useful in the containers of the present invention.

FIG. 5A is a side view of another alternative embodiment of a container of the present invention. FIG. 5B is a top view of the film-seal over the access opening of the embodiment of the container depicted in FIG. 5A.

FIG. 6A is a side view of an alternative embodiment of a dome-shaped lid useful with the containers of the present invention. FIG. 6B is a top view of the lid embodiment depicted in FIG. 6A. FIG. 6C is an enlarged cross-sectional view of the lid depicted in FIG. 6B taken along plane 6C-6C. FIG. 6D is a cross-sectional view of the lid depicted in FIG. 6B taken along plane 6D-6D, and showing details of the modification of rib configurations to match the required oxygen diffusion.

FIGS. 7A and 7B are charts showing the oxygen and carbon dioxide levels for days 0-16 for two different gas mixtures as used in the modified atmosphere package of the present invention.

FIG. 8 is a top view of another lid structure showing alternative sealing mechanisms.

FIG. 9 is a top view of an alternative lid structure showing alternative sealing and package opening means and mechanism.

FIG. 10A is a side view of yet another embodiment of the container of the present invention including pin-holes and a porous label disposed over the pin-holes of the container. FIG. 10B is an enlarged detailed view of the designated portion the embodiment shown in FIG. 10A.

FIG. 11 is a chart showing the calculated rate of oxygen diffusion into a container of the present invention for pin-holes having diameters of 10 microns, 15 microns, and 25 microns, respectively.

FIG. 12 is another embodiment of the container of the present invention showing an alternative bottom structure.

FIG. 13 is a perspective view of a preferred embodiment of the container of the present invention having a removable film hermetically sealing the top of the cup element, as also shown in FIG. 5, and having a substantially dome-shaped lid element relatively loosely disposed thereover.

FIG. 14 is a top view of the embodiment of FIG. 13.

FIG. 15 is a side view of the embodiment of FIG. 13.

### DETAILED DESCRIPTION OF PREFERRED EMBODIMENTS

The present invention is susceptible of embodiment in many different forms. Specific embodiments are shown in the drawings and described in detail in the specification and claims. The present disclosure is an exemplification of the principles of the invention and is not limited to the specific embodiments that are illustrated herein.

The cup-shaped body portion (cup) and the closure portion of the food packaging container of the present invention are made from thermoplastic materials having oxygen permeability properties suitable to the food to be packaged within the container. Preferably at least the cup is made from a multilayer thermoplastic material. The cup also preferably includes functional ribs to modify the surface area of the container and thereby adjust the oxygen permeability of the container and to impart rigidity to the container. The closure portion of the container can be a planar seal, such as a thermoplastic film or sheet, which is heat-sealed over the access opening of the cup. Alternatively, the closure can be a raised profile lid, such as a substantially dome-shaped lid, sealed to the access opening of the cup.

In one preferred embodiment, the closure portion comprises both a planar seal, which is directly sealed to the cup access opening (i.e., an innerseal), and a raised profile lid, which is disposed over the innerseal. In this embodiment, the container comprises two separate compartments. The lower compartment being the cup, and the upper compartment being the space between the raised profile lid and the innerseal. In this embodiment, a fresh food product such as a fresh tortellini pasta, is sealed within the lower compartment (i.e., the cup), and a packet of sauce and/or a packet of grated cheese, for example, can be packaged within the upper compartment. The raised profile lid is preferably secured to the cup by a wrap-around seal, such as a shrink-wrap safety seal, or similar tamper evident expedient, as is well known in the food packaging art.

A consumer purchasing such a packaged food product can remove the tamper evident seal, the raised profile lid, and the sauce and cheese packets. The consumer can then peel away the innerseal, pour the sauce from the packet onto the pasta, and replace the lid on the cup. The sauce can be distributed over the pasta by shaking the contents. Ribs in the cup and/or lid can help in distributing the sauce during the shaking process. The whole container can then be placed in a microwave and the pasta can be cooked within the container, and eaten directly from the container if desired. The cup shape of the container facilitates use in an automobile, for example, where the size of the cup can be selected to fit in a standard size cup holder. The sealed food containers of the present invention thus provide a safe and convenient packaging format for a “meal-on-the-go” product.

Multilayer thermoplastic materials suitable for packaging relatively stable foods (such as cooked meals, meats, cooked vegetables and fruits, baked goods and desserts) include at least one oxygen barrier (i.e., low oxygen permeability) polymer. Oxygen barrier thermoplastic materials are well known in the polymer arts and include, for example, poly(vinyl chloride) (PVC), poly(ethylene-vinyl acetate) (EVA), poly(vinylidene chloride) (PVDC), and the like. Each one of these materials can be extruded or laminated to one or more additional thermoplastic materials. Thermoplastic materials can be laminated to one another with an adhesive or tie layer, such as EVA with an ethylene vinyl alcohol copolymer (EVOH) interlayer.

Preferred non-barrier thermoplastic materials for use in the manufacture of containers of the present invention include poly(styrene-butadiene) (SB), high impact polystyrene (HIPS), oriented polystyrene (OPS), polyethylene terephthalate (PET), low density polyethylene (LDPE), polypropylene (PP), polybutylene (PB), metallocene catalyzed polyolefin (MET), and poly(maleic anhydride) (PMA). Combinations of thermoplastic polymers can be blended and extruded to form a blended layer, or a layer can be formed from a single thermoplastic polymer.

Non-limiting examples of multilayer thermoplastic materials useful for forming containers of the present invention include the following multilayer materials where adjacent layers are indicated by a “/” between the polymer acronyms, and a “-” indicates a blend:

SB/HIPS/OPS-PMA/EVA-EVOH/EVA-BP;

SB/PVDC/LDPE;

HIPS/PVDC/MET;

HIPS/EVOHIMET;

PVC/EVA-EVOH/MET;

HIPS/EVOH/EVA-PB;

PVC/PVDC/LDPE;

PVC/EVA-EVOH/EVA-PB;

PVC/EVA-LDPE;

PVC/EVA-MET;

PET/EVA-EVOH/MET;

PET/EVA-EVOH/EVA-PB;

PET/EVA-LDPE;

PET/EVA-MET;

PP/EVA;

PP/EVA-EVOH/MET;

PP/LDPE.

Additionally at least one surface of the multilayer thermoplastic material includes a heat-sealable polymeric layer, such as a modified polyolefin sealant.

Multilayer thermoplastic materials having an oxygen barrier layer offer low oxygen permeability (i.e. high oxygen barrier) properties, which can be useful for maintaining the freshness of cooked and baked products. Preferably, the oxygen transmission rate of a sealed container constructed from a multilayer thermoplastic material comprising an oxygen barrier layer is no more than about 2.5 cm³/24 hours per container at 20° C. and 0% relative humidity, as determined by ASTM Standard Test Method Number D3985-02 “Standard Test Method for Oxygen Gas Transmission Rate Through Plastic Film and Sheeting Using a Coulometric Sensor”, American Society for Testing and Materials (ASTM International), West Conshohocken, Pa. (2002), the relevant disclosure of which is incorporated herein by reference. More preferably the oxygen transmission rate is in the range of about 0.5 cm³/24 hours to about 2.5 cm³/24 hours per container at 20° C. and 0% relative humidity; most preferably no more than about 0.5 cm³/24 hours.

For highly metabolizing foods such as fresh fruits and fresh vegetables, preferably the oxygen transmission rate of the food container is in the range of about 70 to about 300 cm³/24 hr at 20° C. and 0% relative humidity. Preferably the oxygen level of the atmosphere within the container is in the range of about 0.2% to about 5% by volume, more preferably at least about 1% by volume, most preferably at least about 2% by volume. Under these conditions, fresh fruits and vegetables can continue to respire, but at a reduced rate relative to the respiration rate in a normal, 21% oxygen atmosphere. The gas permeable container allows appropriate amounts of oxygen to enter the cup and carbon dioxide and other respiration gases to diffuse out of the cup to maintain optimum storage conditions for the particular food that is packaged within the container.

Containers for highly metabolizing foods such as fresh fruits and vegetables preferably are constructed from laminates comprising non-barrier thermoplastic polymers, preferably polymers with high oxygen permeability characteristics, i.e., about 400 to about 600 cm³/24 hours/100 in²/atm/mil, such as poly(styrene-butadiene), polyethylene, polypropylene, and the like. These materials are preferably produced by adhesiveless lamination with modified polyethylene heat-sealable film on at least one surface, which allows that the two halves of the package be sealed to each other by application of heat.

The sealed containers of the present invention also preferably have a water vapor transmission rate in the range of about 1 to about 3.5 gram/24 hr at 40° C. and 90% relative humidity, as determined by ASTM Standard Test Method Number F1249-01, “Standard Test Method for Water Vapor Transmission Rate Through Plastic Film and Sheeting Using a Modulated Infrared Sensor”, American Society for Testing and Materials (ASTM International), West Conshohocken, Pa. (2002), the relevant disclosure of which is incorporated herein by reference.

As used herein and in the appended claims, the term “microwaveable” in reference to food containers, means a container that can be utilized for microwave cooking of a food product packaged therein, without the container melting or otherwise softening to the point where the container loses its shape or ceases to be self supporting.

As used herein and in the appended claims, the term “multilayer thermoplastic” means a sheet or film material comprising a plurality of thermoplastic polymeric layers, which are bound together to form a single sheet or film. A multilayer thermoplastic material can be formed by laminating together a plurality of thermoplastic films or sheet, by co-extrusion of two or more thermoplastic films or sheets, or by a combination of lamination and extrusion.

The terms “cup” and “cup-shaped” as used herein and in the appended claims, mean a substantially cylindrical, or tapered cylindrical container that is open at one end, and which has a height dimension greater than its largest diameter dimension.

The term “sealed” as used herein and in the appended claims, in reference to a food packaging container, means that the body portion and closure portion of the container are bonded together in a manner which impedes the free exchange of gases between the interior and exterior of the container.

The term “self-supporting”, as used herein and in the appended claims, in reference to food packaging containers and portions thereof, means that the container or portion thereof retains its shape during storage, transport, retail display, and in use (i.e., microwaving and eating) by the consumer.

The term “raised profile” as used herein and in the appended claims, in reference to a container lid, means a lid having any geometric form which provides a head-space above the level of the access opening of the body portion of the container when the lid is sealed to the access opening. The term “raised profile” includes, without limitation, dome-shaped, bell-shaped, conical, truncated conical, cylindrical, and the like. For convenience, the term “substantially dome-shaped lid” as used herein and in the appended claims includes both dome-shaped and bell-shaped lids, and truncated variations thereof.

The selection of materials of construction for food containers of the present invention, suitable for food products that continue to metabolize such as fresh vegetables, fresh cut fruits and other fresh products, is based on the requirements for diffusion control of oxygen into the container, with the objective of maintaining a lower metabolic rate for the food product, while eliminating from the package evolving carbon dioxide gas, ethylene gas, aromatic metabolites, acetaldehyde, and other gaseous products of metabolism. Since all vegetables and fruits metabolize at different rates, polymers suitable for packaging such products are selected accordingly. Fresh food products with high metabolic rates generally keep better in containers having oxygen permeability properties that allow for a moderate level of oxygen diffusion into the container so that a low level of metabolism can continue when the food product is packaged under a low oxygen atmosphere (e.g. about 0.2% to about 5% oxygen by volume).

The gas permeability of a container is directly proportional to container surface area divided by the wall thickness. The diffusion of gas into and out of the container can be adjusted by modifying the surface area of the container, for example, by fluting or crenelating the container to form ribs.

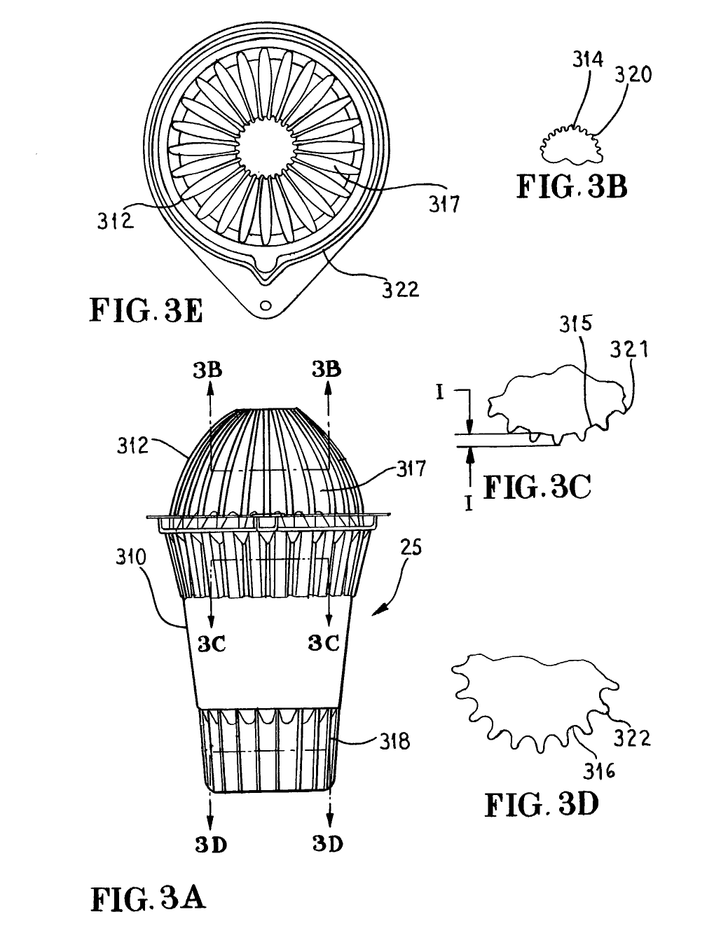

By varying the shape, depth, and number of ribs in the container, it is possible to vary the total surface area of container, as shown particularly in FIGS. 3B, 3C, and 3D, thus varying the rate at which the oxygen can diffuse into the container, such as container 25 in FIG. 3A. With this technique, the desired oxygen transmission rate, suitable for a particular food item, can be obtained. In addition, a raised profile lid, such as a substantially dome-shaped lid can be included in the sealed food container of the present invention to provide a defined head space above the food product packaged therein. The defined head space provides a reservoir of gas over the food product, which helps to maintain a selected, desirable oxygen level within the sealed container.

The described technique to adjust gaseous diffusion into and out of the food containers of the present invention simplifies the process of selecting the required diffusion characteristics for the materials of construction of the containers based on the polymer type and the gauge (thickness) used, for each specified food application. The same multilayer thermoplastic material can provide different oxygen diffusion rates for a given container size simply by varying the surface area of the container and the size of the head space.

A sealed food packaging container of the present invention is self-supporting and rigid enough to resist being crushed during storage, transit, and retail display. A sealed food container of the present invention preferably will deflect no more than about ⅝ of an inch at load of about 70 pounds in a standard crush test such as ASTM Standard Test Method Number D642-00 “Standard Test Method for Determining Compressive Resistance of Shipping Containers, Components, and Unit Loads”, American Society for Testing and Materials (ASTM International), West Conshohocken, Pa. (2002), the relevant disclosure of which is incorporated herein by reference. Preferably, the container will have an average deflection of no more than about ⅜ of an inch at an average load of about 50 pounds, and a deflection of no more than about ¼ of an inch at a load of about 40 pounds according to the ASTM D642-00 test method.

The food containers of the present invention are preferably manufactured by a solventless laminating and thermoforming process as disclosed in U.S. Pat. No. 5,632,133 to Wyslotsky, utilizing a packaging machine such as is depicted and described therein, the relevant disclosures of which are incorporated herein by reference. Packaging machines of this type laminate a rigid polymer with a heat sealable film, and thereafter thermoform the laminate into cups. A fresh food product, such as green lettuce, salad additives, and/or other food products are then loaded into the cup. The machine then applies a closure, such as a lid or a membrane film to each filled cup or container produced by the thermoforming process. During the lidding operation, the air is displaced from the container and is replaced with a gas mixture such as, for example, (a) an oxygen and nitrogen mixture, (b) an oxygen, nitrogen and carbon dioxide mixture, or (c) another suitable, low oxygen, gas mixture having a selected oxygen level appropriate for the food which is being packaged. The closure is then heat-sealed to the cup, the filled, sealed container is cut out of the web and dispensed out of the machine to be packaged into cases, for example, and shipped to distributors or retail outlets.

Since the metabolic rate of various food products such as vegetables and fruits are different, the technique of adjusting the rib design is selectively used to adjust the oxygen transmission rate of the container to match the metabolic rate for each type of food product being packaged, without having a resort to the use of a large number of diverse polymeric materials in the container construction. Simply changing the rib configuration of the thermoforming mold changes the rib configuration on the containers produced by the packaging machine.

Alternatively, the containers of the present invention can be manufactured by multilayer injection blow-molding techniques such as those described in U.S. Pat. No. 6,129, 960 to Kudert et al., the relevant disclosure of which is incorporated herein by reference.

The overall thickness of a multilayer thermoplastic sheet material suitable for constructing the cup portion of a container of the present invention preferably is in the range of about 400 to about 1500 microns, more preferably about 800 to about 1200 microns, most preferably about 900 to about 1200 microns. The thickness of the thermoplastic sheet material for a dome-shaped closure portion of the container is preferably in the range of about 300 to about 1500 microns, more preferably in the range of about 400 to about 500 microns.

The present invention also provides a method of maintaining a controlled level of oxygen within a sealed food packaging container. The method involves providing at least one container including a cup element and a lid element. At least one of the cup and lid elements is composed of a multilayer thermoplastic material having selected oxygen permeability characteristics in order to maintain a selected oxygen level in the container, which will prevent anaerobic microorganisms from developing, while simultaneously providing sufficient oxygen to permit aerobic bacteria to develop and thus indicate spoilage of a food product packaged in the container. A food product is placed in the cup element of the container; and the container is sealed to the outside atmosphere by fusing the cup and lid elements together with a heat sealable film.

In a preferred method aspect, the multilayer thermoplastic material is selected to maintain a constant partial pressure of oxygen within the sealed container at not less than about 0.2% oxygen and not more than about 5% oxygen by volume. Preferably, the container has a defined head space above a food product packaged therein and the volume of the head space is selected in combination with the oxygen permeability characteristics of the multilayer thermoplastic material to maintain the partial pressure of oxygen within the container at the selected, stable level.

In another method aspect, the container includes a porous region having a predetermined porosity, e.g, pin-holes of selected diameter sufficient to permit passage of oxygen into and out of sealed container and optionally a porous label material is disposed over the container pin-holes. Preferably, the pinholes have diameters in the range of about 10 to about 25 microns. The porous label material has micropores with a diameter smaller than the diameter of the pin-holes, preferably no more than about 0.5 microns. The number and size of the micropores and pin-holes can be selected so as to maintain the oxygen level within the closed container at a selected level. Micropores of 0.5 microns in diameter or less prevent entry of microbial contaminants into the container. The oxygen transmission level of the container is selected to complement the metabolic rate of the food packaged within the container. The diffusion of oxygen is matched to the food metabolic rate by selecting a suitable type of polymer, and providing the necessary package surface area by adjustment of the rib dimensions and number of ribs in the container wall.

The oxygen transmission rate of a sealed food container of the present invention can be easily calculated by principles well known in the food packaging art. For example, a 1000 micron thick laminated thermoplastic sheet having an oxygen permeability of about 16.5 cm³/24 hours/100 in²/atm at about 35° F. to about 40° F. storage temperature undergoes a thickness reduction of about 4.83 times during a thermoforming process to form a cup. Due to polymer orientation during thermoforming, which reduces oxygen permeability, the corresponding oxygen permeability of the material only increases by a factor of about 4.4, rather than the full 4.8 times expected due to the reduction in thickness. Hence, the diffusion of oxygen through the walls of a thermoformed cup made from such sheet material, having a total surface area of about 75 in², is about 54 cm³/24 hours:

$$\begin{matrix}Cup {O}_{2} diffusion = 16.5 {cm}^{3} \times 4.4 \times 75 {in}^{2} / 100 {in}^{2} \\ = 54 {cm}^{3} / 24 hours ( to two significant figures ) .\end{matrix}$$

Likewise, a laminated thermoplastic sheet of about 450 micron thickness having an oxygen permeability about 35 cm³/24 hours/100 in²/atm undergoes about 2 times thickness reduction during thermoforming. Again, due to polymer orientation during the thermoforming process, the oxygen permeability of the thermoformed material is not proportional to the thickness reduction. The corresponding oxygen permeability only increases by a factor of about 1.7. Thus, the diffusion of oxygen through a dome-shaped lid having a surface area of about 33 in² is thus about 19 cm³/24 hours:

$$\begin{matrix}Dome {O}_{2} diffusion = 35 {cm}^{3} \times 1.7 \times 33 {in}^{2} / 100 {in}^{2} \\ = 19 {cm}^{3} / 24 hours ( to two significant figures ) .\end{matrix}$$

Accordingly, oxygen diffusion of a food packaging container of the present invention, having the thermoformed cup and lid portions as described above, is about 73 cm³/24 hours.

The sealed food containers of the present invention can include certain optional features such as:

an optional recessed portion of the container to accommodate a fork and napkin, either internally or externally;

a flat bottom for affixing a UPC label and other identification;

a tamper evident seal;

two isolated compartments, with the capability to seal a different gas in each compartment, as described above;

a moisture absorber;

an ethylene gas absorber (i.e., “getter”) to control the rate of ripening of the fruit; and

an oxygen absorber (O₂ getter) such as ferrous oxide in a compartment to control the rate of oxygen diffusion into the container.

The food packaging container of the present invention preferably includes a tapered cylindrical cup bottom of about 2½ inches in diameter. This feature permits the cup to be placed in convenient cup openings or cup holders in the consoles of cars, furniture, serving trays and other locations.

Cups that are preferably about five-inches high can be made from a laminated structure with a polyolefin sealing component on the inside surface of the cup and on the upper surface of the flange of the cup, which can mate and hermetically seal with a corresponding flange having a compatible sealing layer on the lid.

Such five-inch or more high drawn cups can be formed, for example, from a laminated structure comprising styrene-butadiene copolymer laminated and fused thermally with an ethylene vinyl acetate base tie layer and a modified low density polyethylene sealant layer, all of which, when laminated together into a sheet forming a low barrier structure with high gas transmission rate.

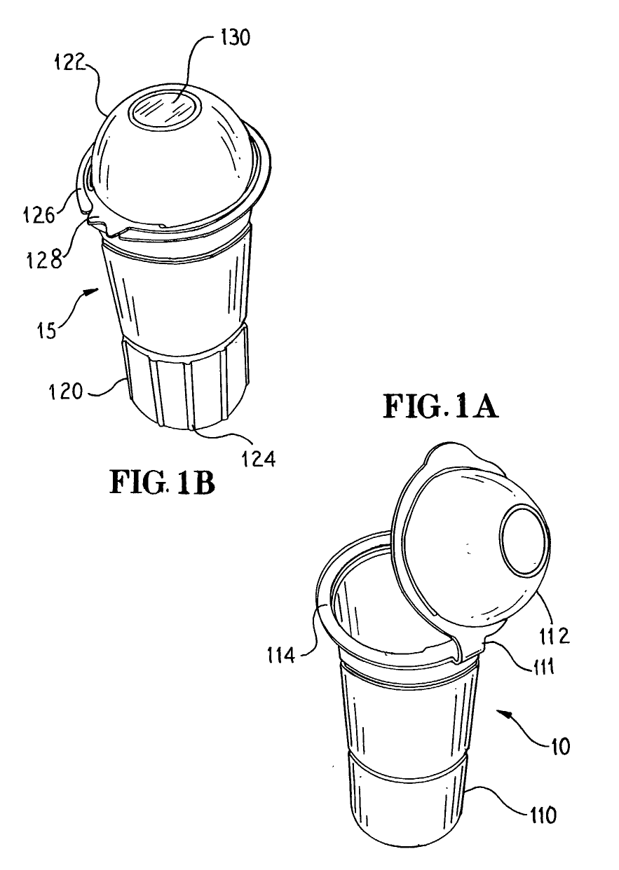

As set forth in FIG. 1A, container 10 includes a cup-shaped body portion (cup) 110, and a raised profile closure such as dome-shaped closure (lid) 112. Lid 112 is hingedly attached to cup 110 by a flexible hinge 111. Cup 110 includes a flanged finish 114, which provides a surface for sealing lid 112 to cup 110. The surface of finish 114 comprises a heat-sealable polymeric material (heat-seal), as does the corresponding mating surface on lid 112. When lid 112 is placed in contact with cup finish 114, application of heat to the interface between the lid 110 and the finish 114, fuses lid 112 to cup 110 to form a sealed container. Typically, the strength of the heat-seal is selected so that a consumer can peel lid 112 away from cup 110, to open the container.

FIG. 1B illustrates an external view of another food container embodiment of the present invention. Container 15 includes a cup-shaped body portion (cup) 120 and a dome-shaped lid portion (lid) 122 heat-sealed to cup 120. Cup 120 includes vertical ribs 124. Dome-shaped lid 122 has a substantially flat top 130, and includes a flange 126, and a peelable seal 128. The sealed container 15 can be opened by grasping the peelable seal 128 and pulling it away from lid 122. Peelable seal 128 is formed by circumferentially scoring a portion of flange 126 to create a point of weakness in the flange that is tearable. Only the outer portion of flange 126 is sealed to cup 120, and the flanged is scored in an area inward from the heat-sealed portion. Tearing away peelable seal 128 completely removes the heat-sealed portion of the container 15, thus allowing lid 122 to be removed from cup 120.

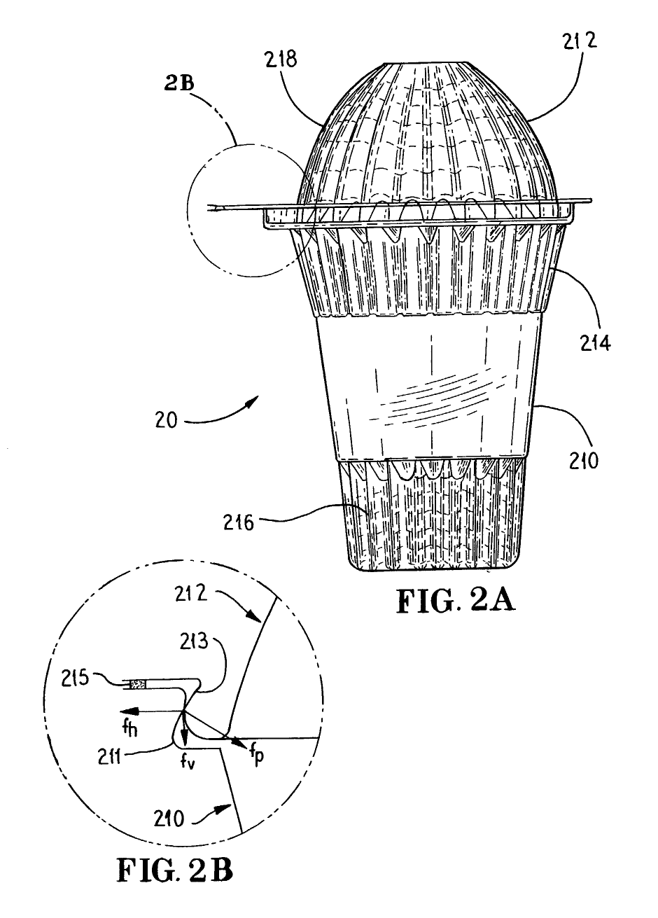

A preferred embodiment of the sealed food container of the present invention is shown in FIG. 2A. Container 20 includes cup 210 and dome-shaped lid 212. As shown in FIG. 2B, lid 212 is held in contact with cup 210 by a spring-like force supplied by a flexible rim 213 on lid 212, which snaps into a complementary flange 211 of cup 210. The oversized dimension of the rim 213 exerts force (fₚ) against the corresponding flange 211 on cup 210. The two components of the force fₚ are horizontal force fₕ and vertical component fᵥ. Thus, the force fₚ holds cup 210 and lid 212 together while the seal 215 provides a hermetic seal between lid 212 and cup 210.

Container 20 also includes vertical ribs 214 and 216 in the cup 210, and longitudinal ribs 218 in lid 212. The vertical ribs 214 and 216 provide several functional features. For example, the fluted nature of ribs 214 and 216 add structural strength to the cup, allowing for an overall thinner wall thickness than a non-ribbed cup of the same internal volume and nominal dimensions, while allowing the cup to remain self-supporting. The thinner wall thickness can provide a significant cost savings in manufacture of the cup. In addition, vertical ribs 214 and 216 increase the surface area of the cup relative to a non-ribbed cup of the same internal volume and nominal dimensions. By varying the depth and number of ribs 214 and 216, the surface area, and thus the oxygen permeability of the cup 210 can be varied. As described above, it is desirable to select the oxygen permeability of the cup to match the food product that is to be packaged therein. The longitudinal ribs 218 in lid 212 also provide added strength and increased surface area.

FIGS. 3A through 3E illustrate how rib features such as depth, shape and number of ribs can be varied in a sealed food container of the present invention. FIG. 3A illustrates a side elevation view of container 25. In FIG. 3A, both the lid 312 and cup 310 include ribs 317, 318, and 319. The profile of ribs 317, 318 and 319 through different planes, 3B-3B, 3C-3C, and 3D-3D of container 25 are illustrated in FIGS. 3B, 3C, and 3D, respectively. As shown in FIG. 3B, longitudinal ribs 317 in the lid portion 312 of container 25 have a fluted profile with a shallow portion 314 and an extended portion 320. Vertical ribs 318 in the upper portion of cup 310, have a crenellated shape, wherein the shallow portion 315 is flattened out relative to the extended portion 321, as illustrated in FIG. 3C. The depth I of ribs 318 can be selected to vary the surface area of the cup 310. Vertical ribs 319 in the lower portion of cup 310, have a simple fluted profile, as illustrated in FIG. 3D, which is a partial cross-section through plane 3D-3D. FIG. 3E illustrates a top view of lid 312, showing ribs 317, and a seal 322, which is positioned inward from the circumference of lid 312.

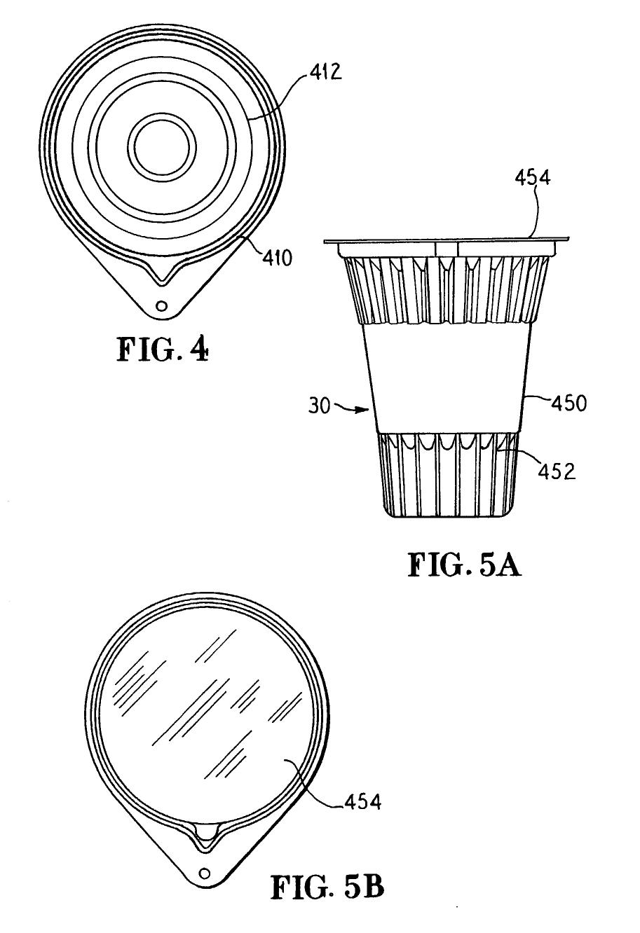

FIG. 4 illustrates a top view of an alternative embodiment of a dome-shaped lid 122 of FIG 1B, in which the lid 410 includes latitudinal grooves 413 and a peelable seal 412 inward from the circumference of lid 410.

In FIGS. 5A and 5B, container 30 includes a cup-shaped body portion 450, and a planar seal, such as an innerseal 454, heat-sealed over the access opening of cup 450. FIG. 5B is a top view of container 30 illustrating film innerseal 454 sealed over the opening of cup 450.

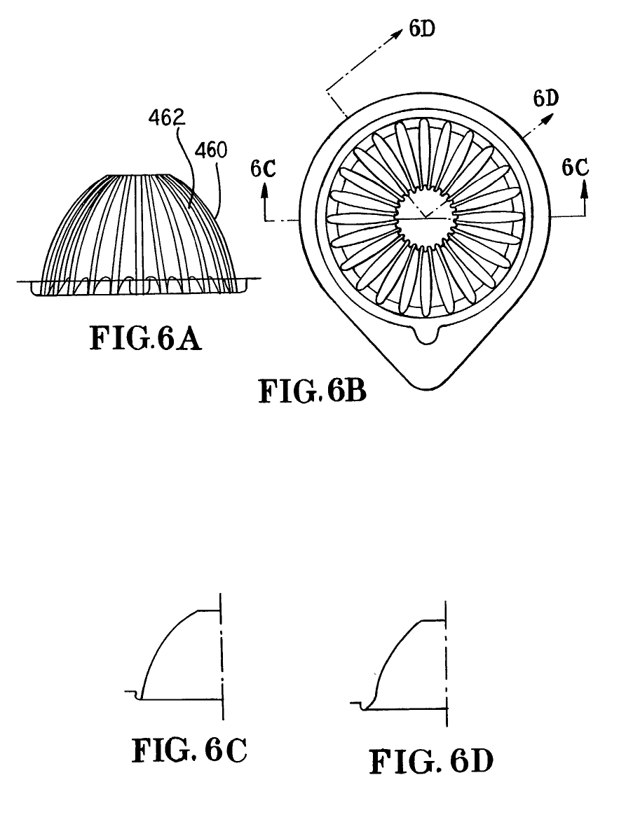

FIGS. 6A through 6D illustrate profile features of a dome-shaped lid 460, including longitudinal ribs 462, which is similar to lid 312 in FIGS. 3A and 3E. FIG. 6C is a profile taken through plane 6C-6C, along an extended portion of rib 462. FIG. 6D is a profile taken through plane 6D-6D, along a shallow portion of rib 462.

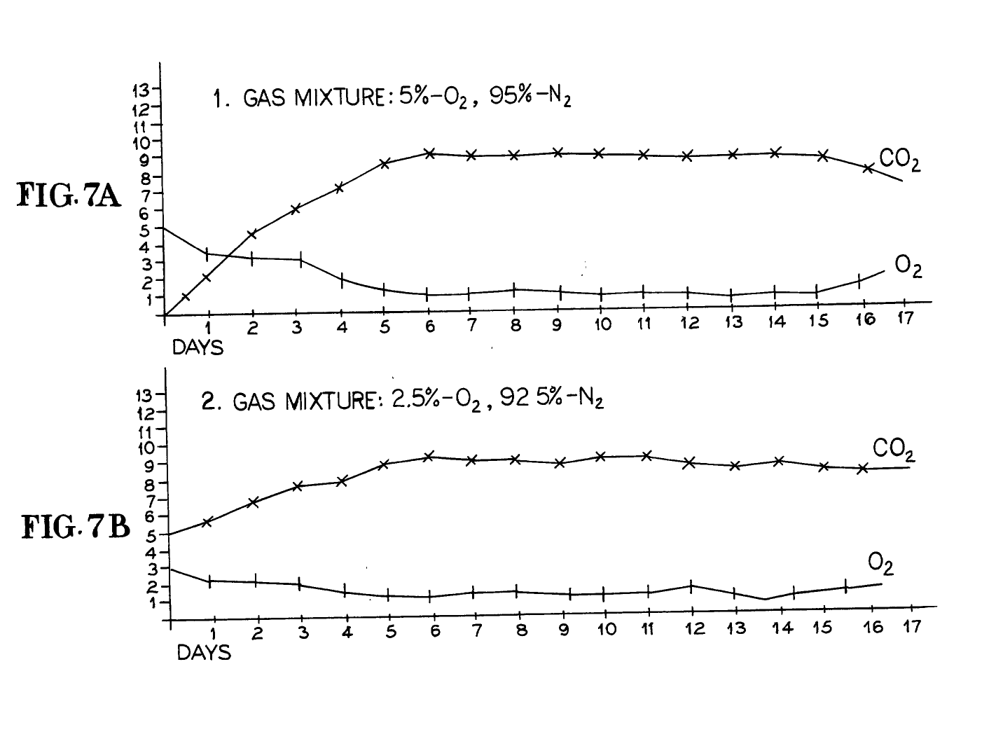

In the following example, the containers were manufactured according to the process described in U.S. Pat. No. 5,632,133 to Wyslotsky. A laminated sheet material having a nominal thickness of about 1000 microns was prepared by coextrusion of a clear styrene-butadiene copolymer with SURLYN® brand polyolefin sealant (DuPont) modified with polybutylene and with an ethylene vinyl acetate (EVA) tie layer. The sheet was molded into cup forms as depicted in FIG. 3A (dimensions given below), the cups were filled with 4 oz of fresh mixed lettuce, closed with dome-shaped lids as depicted in FIG. 3A (dimensions given below). The air in the container was replaced with a gas mixture of about 5% oxygen and about 95% nitrogen or about 2.5% oxygen and 97.5% nitrogen. The lids were sealed to the cups by application of heat to the flanged interface between the cups and lids as is well known in the packaging art and the filled, sealed containers were cut from the web. The oxygen level within the container was monitored over a period of about 16 to 17 days by ASTM Standard Method D3985-02. The oxygen levels within the containers were graphed and are represented by FIGS. 7A and 7B. The surface area of the cups were about 108 square inches, and the oxygen diffusion into and out of the container was about 74 cm³/24 hr. The containers were loaded with about 4 oz. of mixed lettuce salad at a partial pressure of oxygen of about 1.0% to about 2.5% at a storage temperature of about 35° to about 42° F.

As shown in FIG. 7, for two different gaseous mixtures, about 1.0% and about 2.5% oxygen in nitrogen, the diffusion of oxygen for a 4 oz. mixed lettuce salad packaged in the containers described above, at storage temperature of about 35° to about 40° F. reaches equilibrium without totally depleting the oxygen from the food packaging container, thus maintaining the product freshness over an extended period of time of 14 to 21 days.

Commercially available rigid polymers for making small containers typically have diffusion rates for oxygen and other gases that are below the diffusion rate necessary to preserve the freshness characteristics of metabolically active products such as fresh vegetables and fruits. Prior to the food packaging containers of the present invention, the industry has typically used a rigid container in a shape of a large bowl with a thin web lid sealed to the rigid container. In a cup configuration a thin web seal cannot diffuse the necessary quantity of the oxygen through a relatively small area of the cup opening. Through the use of the food packaging containers of the present invention, the diffusion of oxygen through the walls of the cup as demonstrated herein, supplements the diffusion through the lid or a membrane seal. Oxygen diffusion through the entire surface area of the container provides sufficient oxygen diffusion into the package to maintain the product's freshness.

In the present invention, surface area enlargement by incorporating fluted or crenelated ribs, for example, in the container achieves the necessary diffusion and transmission of oxygen through the walls of the container and thus maintains the freshness of products packaged therein.

Additionally, the ribs of the food packaging container of the present invention can also be configured to act as agitators to assist in the blending of food components packaged therein such as the dressing and other condiments with lettuce and other salad components when the container is shaken.

In some preferred embodiments, the food packaging container of the present invention can contain lettuce and small packets of other products, such as dressing, croutons, and condiments stored in the space under the raised profile lid. The consumer can purchase a single, or multiple-serving package and can open it by removing a tamper evident seal. Small packages containing salad fixings, for example, can then be removed and the contents poured onto the salad. The lid is then snapped back onto the cup. The salad can then be mixed by shaking the container, thereby dispersing the contents for uniform distribution. The ribs, during shaking, help to disperse salad dressing and other components uniformly. Specifically, the ribs function to stop the rotation of the lettuce around the periphery, while the center of the product can move freely, which provides for a differential motion useful for efficient mixing. Additionally, the lid can be used for storing uneaten portions of the food in the container for later consumption.

In the case of low oxygen diffusion containers, the shelf life characteristics of fresh vegetables and fruits can also be improved by channeling the gaseous atmosphere of the cup around the food product in contact with the inner surface of the cup. In a conventional oxygen non-diffusing cup without ribs with a diffusing lid, the metabolizing food items that adhere to the walls do not receive the necessary supply of oxygen leading to spoilage. It is therefore a feature of the present invention that the rigid non-diffusing cup for packaging vegetables, when equipped with product spacing ribs, does improve the shelf life of the metabolizing fruits and vegetables.

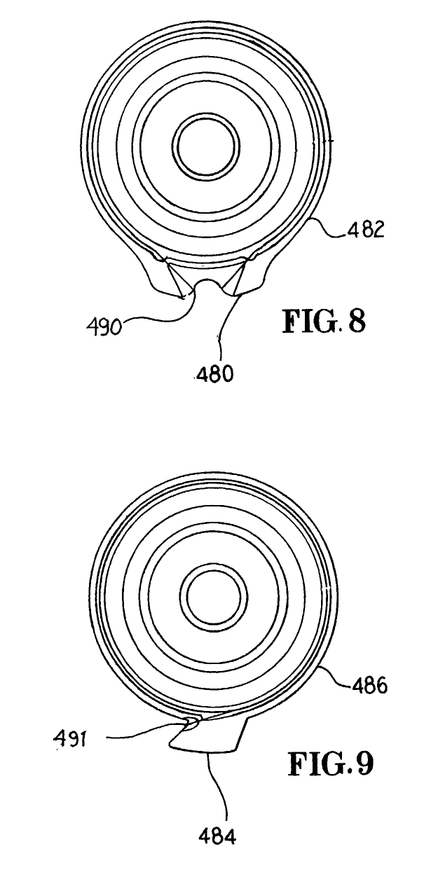

A “strippable seal” as used herein refers to a mechanism for sealing a container as described in U.S. Pat. No. 5,079,059 to Wyslotsky, the relevant disclosure of which is incorporated herein by reference. The strippable-seal as shown FIGS. 8 and 9 involves a fusion of the extreme outer edge of the lid flange to the extreme outer edge of the finish of the cup. The lid and the cup finish are scored, just inward from the fused seal. A tab (480 in FIG. 8 and 484 in FIG. 9) is provided, which allows a consumer to tear the fused portion (482 in FIG. 8 and 486 in FIG. 9) of the lid and cup away from the container. The material of the lid and cup tears along the score lines (490 in FIG. 8 and 491 in FIG. 9) provided on the lid and cup. Tearing (stripping) away the fused portion breaks the seal of the container and allows the lid to be removed from the cup. Preferred methods of opening the containers of the present invention include a peelable-seal lid, as shown in FIG. 4, and two versions of a strippable-seal opening as shown in FIGS. 8 and 9 which are tamper evident for the consumer safety.

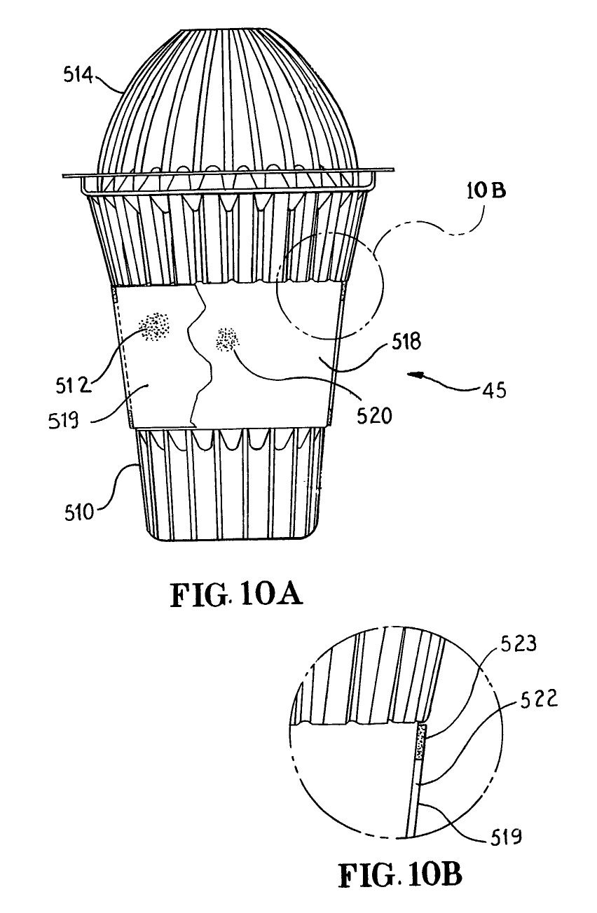

FIGS. 10A and 10B show another means of controlling oxygen diffusion through the container for the purpose of extending the useful shelf life of the product being packaged therein. This embodiment offers the freedom to use any thermoformable polymer with high or low diffusion (transmission) rate of gases into the package and to provide a controlled supply of oxygen into the package.

In container 45, shown in FIGS. 10A and 10B, a non-ribbed portion 518 of the cup 510 includes a region of pin-holes 520 which allow oxygen and other gases to diffuse into and out of the container. A porous label 519 is secured over the non-ribbed portion 518 of cup 510. The porous label 519 can be affixed to the non-ribbed portion 518 of cup 510 by, for example, a bead of adhesive 523 disposed around the upper and lower inside edges of label 519. Gases can pass freely through the pin-holes 520 in cup 510 into the space 522 between label 519 and cup 510. Pores 512 in label 519 allow the gases to diffuse away from container. Pin-holes 520 preferably have a diameter in the range of about 10 to about 25 microns to allow oxygen to enter container 45. The number of the pin-holes 520 regulates the amount of oxygen allowed to enter container 45. These pin-holes 520 also allow carbon dioxide gas and other metabolites to escape the container.

Suitable materials for porous label 519 include conventional paper, high oxygen diffusion expanded polypropylene or expanded polyethylene, and like materials. Preferably the pores 512 have diameters no greater than about 0.5 micron. A pore size of less than about 0.5 microns prevents microorganism contaminants from penetrating the space between the label and the body of the cup, and subsequently penetrating the container.

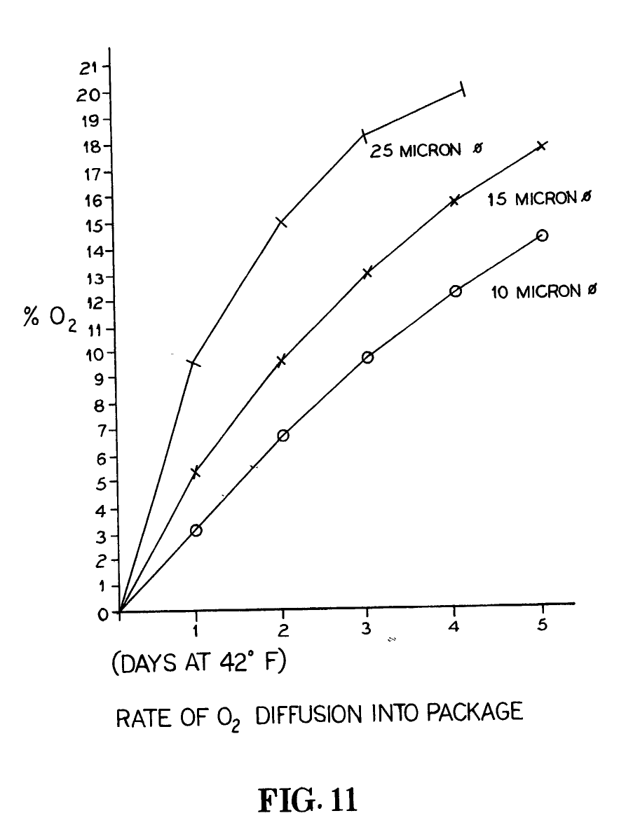

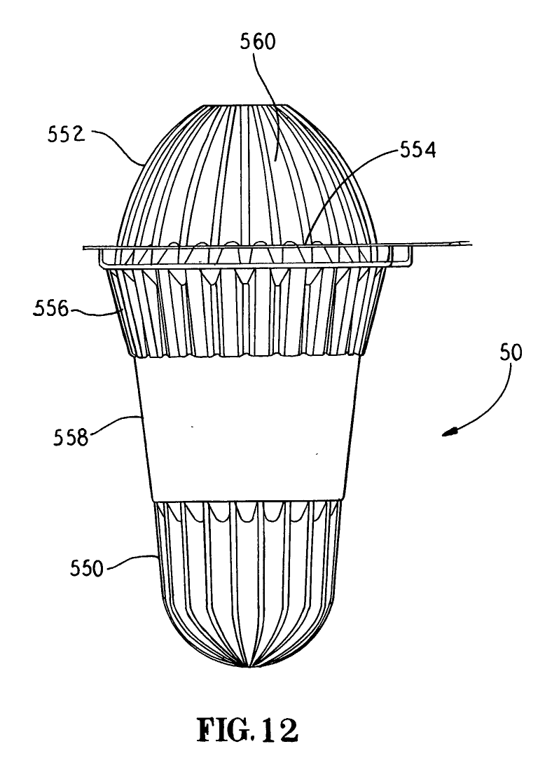

A food packaging container of the present invention, as shown for example in FIGS. 10A and 10B having a volume of about 750 cm³ will contain about 157 cm³ of oxygen when empty and containing normal air (20.9% oxygen by volume). The oxygen transmission for a container having various size pin-holes can be calculated, and values for pin-hole sizes of 10, 15 and 25 microns are shown in Table 1, and graphed in FIG. 11.

TABLE 1
Oxygen Diffusion Per Day+HZ,1/32

| | | | | |
|---|---|---|---|---|
| Pin Hole Size | Day 1 | Day 2 | Day 3 | Day 4 |
| 25 micron | 72.00 cm³ | 38.25 cm³ | 26.25 cm³ | 24.37 cm³ |
| 15 micron | 39.75 cm³ | 30.00 cm³ | 24.00 cm³ | 21.00 cm³ |
| 10 micron | 26.25 cm³ | 23.25 cm³ | 20.25 cm³ | 19.00 cm³ |

Hence, the rate of oxygen transmission into the container changes downwardly as partial pressure of oxygen diminishes, as shown graphically in FIG. 11.

Other preferred embodiments of the present invention are directed to low oxygen food packaging containers composed of high oxygen barrier materials. In many applications of food packaging, to prevent the proliferation and toxic germination of Clostridium botulinum, it is necessary to maintain a constant minimal level of oxygen in the package. Such applications include meats, prepared meals, and fresh vegetables with high water activity and high pH. In the absence of oxygen, these foods can provide conditions for sporulating Clostridium botulinum microorganisms. However, even a relatively low oxygen partial pressure tends to prevent such sporulation, and thus increase safety, while, a relatively high partial pressure of oxygen in the package can cause food oxidation. It is therefore recommended to maintain a constant partial pressure of oxygen for most foods of at least about 0.2% to no more than about 5% by volume of oxygen, preferably no more than about 1% oxygen. Furthermore, the presence of a relatively low partial pressure of oxygen in the package will allow for development of relatively innocuous aerobic microorganisms, which develop odor, slime, and other detectable organoleptic characteristics before anaerobic microorganisms reach dangerous levels for the consumption of the food. Accordingly, the presence of the traces of oxygen in food container is useful for the purpose of inhibiting development of Clostridium botulinum and allowing for eventual formation of odor and other organoleptic indicators of spoilage when the food has exceeded its shelf life.

The technology developed for controlling the oxygen levels in the food packaging containers of the present invention is also very useful for reduced-oxygen packaging of various foods in which the circumstances require safety measures. Such food include prepared meals, baked goods, meats, sandwiches and any other foods prone to botulinum contamination or otherwise requiring a low-oxygen storage atmosphere.

This technology consists of (a) determining the rate of depletion of oxygen in a package containing the food and (b) adjusting the oxygen transmission characteristics of the container to replenish oxygen that is consumed by the food, with the ultimate objective of maintaining a constant partial pressure of oxygen in the container.

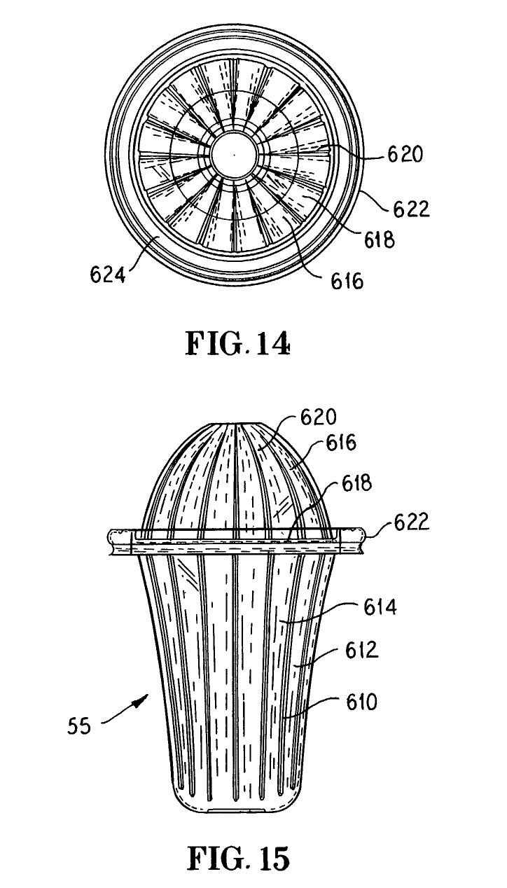

Other embodiments of the food packaging container of the present invention for extended shelf life are depicted in FIGS. 12, 13, 14, and 15.

FIG. 12 illustrates an alternative configuration of the cup element of the food containers of the present invention. Container 50 includes a cup element 550 having a rounded bottom, and a substantially dome-shaped, flat topped lid element 552. Cup 550 includes vertical ribs 556 and a non-ribbed portion 558 onto which a label can conveniently be attached. Lid 552 also includes ribs 560. A planar seal such as a thermoplastic film innerseal 554 is disposed between cup 550 and lid 552, and is heat sealed to the open end of cup 550. Innerseal 554 effectively creates two separate chambers in the sealed food package, one in cup 550, useful for storage of a main food product, and a smaller chamber under dome 552, useful for storage of condiments, sauce packets, and the like. The container 50 of FIG. 12 can be displayed with the cup 550 on the top and the lid 552 on the bottom (i.e., inverted from the view depicted in FIG. 12) if desired.

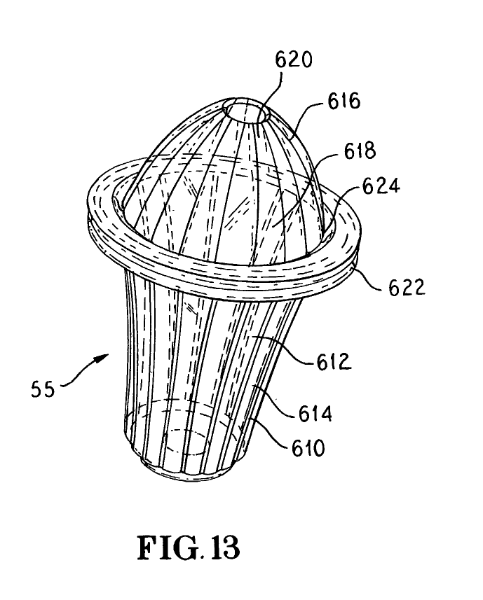

FIGS. 13, 14 and 15 depict various views of another preferred embodiment of the sealed food container of the present invention. Container 55 includes a cup portion 610, having fluted vertical ribs 614, and a substantially dome-shaped lid 616. Lid 616 has an oversized rim 622, which fits over the opening of cup 610. A planar seal 618 is disposed between cup 610 and lid 616 and is sealed to the open end of cup 610, defining two separate chambers 612 and 620. Chamber 612 is defined by cup 610 and planar seal 618, and is useful for storage of a main food item. Chamber 620 is defined by dome-shaped lid 616 and planar seal 618, and is useful for storage of condiments, sauces, and other “fixings” that can be added to the main food product by a consumer after the container has been opened and planar seal 618 removed. Lid 616 also includes a recessed portion 624 which serves to lock lid 616 to cup 610 when the lid is replaced on cup 610 after planar seal 618 has been removed, thus preventing leakage of any liquid components from the container if it is shaken by the consumer.

The planar seal can comprise a thermoplastic film or thermoplastic sheet material. The planar seal preferably has a thickness in the range of about 20 to about 45 mils.

The sealed food containers of the present invention offer a number of advantages over conventional food packaging containers. The containers are both microwaveable, and substantially transparent, thus allowing the consumer to visually inspect the food product at the point of sale, and prior to use. This provides an advantage for marketing as well as a safety advantage for the consumer (i.e., the consumer can look for visual signs of contamination or decay). Other advantages of the invention include improved shelf-life due to the unique matching of oxygen transmission of the container to the metabolic rate of the food, and the ability of the sealed containers to maintain a stable, selected reduced-oxygen atmosphere over the food product.

From the foregoing it will be appreciated that, although specific embodiments of the invention have been described herein for purposes of illustration, various modifications may be made without deviating from the spirit and scope of the invention. Accordingly, the invention is not limited except as by the appended claims.

We claim:

1. A sealed, controlled-atmosphere food container which comprises:
a substantially transparent, self-supporting, microwaveable, multilayer thermoplastic cup-shaped body portion having an access opening; and
a thermoplastic closure portion heat-sealed over the access opening of the cup-shaped body portion;
wherein the body portion and the closure portion each have selected oxygen permeability characteristics whereby the sealed container is capable of maintaining a substantially stable, reduced-oxygen atmosphere over a food product sealed within the container, when the container is exposed to ambient atmoshphere.

2. The food container of claim 1 wherein the closure portion comprises a planar seal over the access opening.

3. The food container of claim 2 wherein the planar seal has a thickness in the range of about 20 to about 45 mils.

4. The food container of claim 2 wherein the planar seal comprises a thermoplastic film.

5. The food container of claim 2 wherein the planar seal comprises a thermoplastic sheet.

6. The food container of claim 2 further comprising a raised profile lid disposed over the planar seal.

7. The food container of claim 6 wherein the raised profile lid is substantially dome-shaped.

8. The food container of claim 6 wherein the lid includes longitudinal ribs.

9. The food container of claim 8 wherein the ribs are flutes or crenelations in the lid.

10. The food container of claim 6 wherein the cup-shaped body portion includes vertical ribs.

11. The food container of claim 10 wherein the ribs are flutes or crenelations in the body portion.

12. The container of claim 1 wherein the cup-shaped body portion includes vertical ribs.

13. The food container of claim 12 wherein the ribs are flutes or crenelations in the body portion.

14. The food container of claim 1 wherein the closure portion comprises a multilayer thermoplastic material.

15. The food container of claim 14 wherein the multilayer thermoplastic material comprises at least one layer of an oxygen barrier polymer.

16. The food container of claim 15 wherein the oxygen barrier polymer is selected from the group consisting of poly(vinyl chloride), poly(vinylidene chloride), poly(ethylene-vinyl acetate), nylon, poly(styrene-acrylonitrile), poly(styrene-methacrylonitrile), and a mixture thereof.

17. The food container of claim 15 wherein the oxygen barrier polymer comprises poly(ethylene vinyl acetate).

18. The food container of claim 1 wherein the multilayer thermoplastic includes at least one oxygen barrier polymer layer.

19. The food container of claim 18 wherein the oxygen barrier polymer is selected from the group consisting of poly(vinyl chloride), poly(vinylidene chloride), poly(ethylene-vinyl acetate), nylon, poly(styrene-acrylonitrile), poly(styrene-methacrylonitrile), and a mixture thereof.

20. The food container of claim 18 wherein the oxygen barrier polymer comprises poly(ethylene vinyl acetate).

21. The food container of claim 18 wherein the sealed container has an oxygen transmission rate of no more than about 2.5 cm³/24 hrs at 20° C. and 0% relative humidity.

22. The food container of claim 18 wherein the sealed container has an oxygen transmission rate of no more than about 0.5 cm³/24 hrs at 20° C. and 0% relative humidity.

23. The food container of claim 18 wherein the multilayer sealed container has an oxygen permeability in the range of about 0.5 to about 2.5 cm³/24 hrs at 20° C. and 0% relative humidity.

24. The food container of claim 1 wherein multilayer thermoplastic comprises at least one polymer layer selected from the group consisting of poly(styrene-butadiene), high impact polystyrene, oriented polystyrene, polyethylene terephthalate, low density polyethylene, polypropylene, polybutylene, metallocene catalyzed polyolefin, poly(maleic anhydride), and a combination thereof.

25. The food container of claim 1 wherein the multilayer thermoplastic comprises at least about 3 layers of thermoplastic polymers.

26. The food container of claim 1 wherein the multilayer thermoplastic comprises at least about 5 layers of thermoplastic polymers.

27. The food container of claim 1 wherein the sealed container has an oxygen transmission rate in the range of about 70 to about 300 cm³/24 hrs at 20° C. and 0% relative humidity.

28. The food container of claim 1 wherein the body portion of the container has a deflection of no more than about 0.25 inches at a load of about 40 pounds, and no more than about 0.63 inches at a load of about 70 pounds in a compressive resistance test.

29. The food container of claim 1 wherein the closure portion comprises a raised profile lid.

30. The food container of claim 29 wherein the raised profile lid is substantially dome-shaped.

31. The food container of claim 29 wherein the raised profile lid includes longitudinal ribs.

32. The food container of claim 31 wherein the longitudinal ribs are flutes or crenelations in the lid.

33. The food container of claim 29 wherein the container body portion includes vertical ribs.

34. The food container of claim 33 wherein the vertical ribs are flutes or crenelations in the body portion.

35. The food container of claim 1 wherein the closure portion is a substantially dome-shaped lid; the container body portion including vertical ribs and the dome-shaped lid including longitudinal ribs.

36. The food container of claim 35 wherein the ribs are flutes or crenelations in body portion and the lid.

37. The food container of claim 1 wherein at least the body portion is manufactured by a thermoforming process.

38. The food container of claim 1 wherein at least the body portion is manufactured by an injection blow-molding process.

39. The food container of claim 1 wherein the closure is hermetically sealed to the body portion.

40. A sealed, controlled-atmosphere food container which comprises:
a substantially transparent, self-supporting, microwaveable, multilayer thermoplastic cup element having an access opening; and
a thermoplastic closure element heat-sealed over the access opening of the cup-shaped body portion;
at least a portion of the cup element defining pin-holes having a diameter sufficient to allow oxygen to diffuse therethrough; the portion of the cup element which defines pin-holes being covered by a porous label defining micropores having diameters less than the diameters of the pin-holes.
wherein the sealed container is capable of maintaining a substantially stable, reduced-oxygen atmosphere over a food product sealed within the container and exposed to ambient atmosphere.

41. The food container of claim 40 wherein the porous label comprises a material selected from the group consisting of paper, expanded polyethylene, and expanded polypropylene.

42. The food container of claim 40 wherein the pin-holes have diameters in the range of about 10 to about 25 microns and the micropores have diameters no greater than about 0.5 microns.

43. The food container of claim 40 wherein a planar seal is provided over the access opening of the cup element and the lid is disposed over the planar seal.

44. The food container of claim 43 wherein the planar seal has a thickness in the range of about 20 to about 45 mils.

45. A method of maintaining a controlled level of oxygen within a sealed food packaging container, the method comprising the steps of:
(a) providing at least one container including a cup element and a lid element, at least one of the cup and lid elements being composed of a multilayer thermoplastic material having selected oxygen permeability characteristics to maintain oxygen in the container at a level between the oxygen level which will prevent anaerobic microorganisms from developing, and an oxygen level sufficient to permit aerobic bacteria to develop and thus indicate spoilage of a food product packaged therein;
(b) placing a food product within the cup element of the container; and
(c) sealing the container to the outside atmosphere by fusing the cup and lid elements together with a heat sealable film.

46. The method of claim 45 further comprising:
selecting the multilayer thermoplastic material to maintain a constant partial pressure of oxygen within the sealed container of at least about 0.2% oxygen and no more than about 5% oxygen by volume.

47. The method of claim 45 wherein the container has a defined head space above a food product packaged therein; and
the head space volume maintains the partial pressure of oxygen within the container at a selected, stable level.

48. The method of claim 45 wherein the container has pin-holes of selected diameter sufficient to permit passage of oxygen therethrough and into the container; and a porous label material over the container pin-holes; the porous label material having micropores with a diameter of no more than about 0.5 microns so as to maintain the oxygen level within the closed container at a selected level and to prevent entry of microbial contaminants into the container.

49. The method of claim 48 wherein the label comprises a material selected from the group consisting of paper, expanded polyethylene, and expanded polypropylene.

50. The method of claim 45 the container has flutes or crenelations in at least one of the cup element and lid element for increasing the absolute value of oxygen permeability of the sealed container.

51. The method of claim 50 wherein the size and number of the flutes or crenelations controls the surface area of the container available for oxygen transmission.

52. The method of claim 45 wherein the container comprises cup and lid elements with a heat-sealable thermoplastic film disposed therebetween and sealed to the cup element.

53. The method of claim 52 wherein the lid element comprises a substantially dome-shaped lid hermetically sealed to the cup.
